(19) United States
(12) Patent Application Publication
(10) Pub. No.: US 2023/0183049 A1
(43) Pub. Date: Jun. 15, 2023

(54) SYSTEM AND METHOD FOR ACCESS CONTROL FOR A ROBOTIC VEHICLE

(71) Applicant: STOCKED ROBOTICS, INC., Austin, TX (US)

(72) Inventor: Kuldipsingh Pabla, San Jose, CA (US)

(73) Assignee: STOCKED ROBOTICS, INC., Austin, TX (US)

(21) Appl. No.: 17/551,490

(22) Filed: Dec. 15, 2021

(51) Int. Cl. B66F 9/075; G05D 1/00; G06F 21/31; G06F 21/44; B60R 25/20; B60R 25/04; G07C 5/00

(52) U.S. Cl. CPC B66F 9/07581; G05D 1/0027; G06F 21/31; G06F 21/44; B60R 25/2018; B60R 25/04; G07C 5/006; G05D 2201/0216; G06F 2221/2141

(57) ABSTRACT

A system for managing a fleet of robotic vehicles comprising a plurality of robotic vehicles, each including a processor controller operating under algorithmic control, wherein the processor controller of each vehicle is configured to prevent operation of the robotic vehicle by an unauthorized user and a central controller operating on a remote processor, wherein the remote processor is configured to interface with the plurality of robotic vehicles and to modify data associated with an authorized user for each of the plurality of robotic vehicles.

### TECHNICAL FIELD

The present disclosure relates generally to robotic vehicles, and more specifically to systems and methods for access control for robotic vehicles that allows a user and administrator to flexibly control access.

### BACKGROUND OF THE INVENTION

Robotic vehicles can perform certain functions, but access to the robotic vehicles can render them unsafe and subject to unauthorized use.

### SUMMARY OF THE INVENTION

A system for managing a fleet of robotic vehicles comprising a plurality of robotic vehicles, each including a processor controller operating under algorithmic control, wherein the processor controller of each vehicle is configured to prevent operation of the robotic vehicle by an unauthorized user and a central controller operating on a remote processor, wherein the remote processor is configured to interface with the plurality of robotic vehicles and to modify data associated with an authorized user for each of the plurality of robotic vehicles.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings may be to scale, but emphasis is placed upon clearly illustrating the principles of the present disclosure. Moreover, in the drawings, like reference numerals designate corresponding parts throughout the several views, and in which:

FIG. 1 is a diagram of a system for managing a fleet of robotic vehicles, in accordance with an example embodiment of the present disclosure; and

FIG. 2 is a diagram of a method for managing a fleet of robotic vehicles, in accordance with an example embodiment of the present disclosure.

### DETAILED DESCRIPTION OF THE INVENTION

In the description that follows, like parts are marked throughout the specification and drawings with the same reference numerals. The drawing figures may be to scale and certain components can be shown in generalized or schematic form and identified by commercial designations in the interest of clarity and conciseness.

Robotic vehicles are often operated by an operator, who can exercise local control over the vehicle while performing other tasks. For example, a robotic fork lift can be used to allow the operator to load and unload materials, such as when the forklift drives by storage bays. The robotic fork lift can go to predetermined locations, follow the operator or perform other suitable functions, while the operator takes materials off the forklift and stores the materials in storage bays, or takes materials out of the storage bays and assembles it on the forklift as part of an order.

However, there are a number of problems with such environments. An untrained operator can access a robotic fork lift and possibly operate it in an unsafe manner, such as if it is left unlocked after a licensed operator's shift ends. A fork lift can be operated even when it requires service and is in an unsafe condition. Likewise, if a fork lift is involved in an accident, such as if it runs into a wall and causes damage to the wall, the operator can elect to leave the scene of the accident to try and hide the operator's involvement in the accident.

In order to protect against these and other problems, the present disclosure provides a system and method for managing access to robotic vehicles as part of a fleet. The present disclosure allows a fleet operator to configure each vehicle to allow predetermined operators to access a vehicle at predetermined times, locations and under predetermined conditions. In this manner, unauthorized access to a robotic vehicle can be prevented, and the vehicle can also or alternatively be unlocked if it is determined that such situations do not exist or have been addressed. Unauthorized access can include one or more of the following situations or other suitable situations:
1. A vehicle is locked using the disclosed systems and/or methods if it fails to satisfy an Occupational Safety and Health Administration (OSHA) checklist or inspection, which could reflect that the vehicle requires maintenance and that it is dangerous to operate under such conditions.
2. A vehicle is locked using the disclosed systems and/or methods if it runs into an accident with predetermined level of impact force that is configurable, to prevent the operator from further damaging the vehicle or from covering up the accident, and also to ensure that the vehicle obtains proper repairs.
3. A vehicle/or a set of vehicles can be locked using the disclosed systems and/or methods if they are not required, such as due to seasonal workload requirements or other reasons. For instance, during holidays, if there are not enough operators of if there is not enough workload, a supervisor can remotely lock a set of vehicles and take them out of operation.
4. A vehicle can be locked using the disclosed systems and/or methods when an operator ends their shift, so that no one can operate it until they are authenticated and authorized.
5. An operator can have a permit to operate a certain class of vehicles, and if the operator tries to operate a vehicle they do not have permit for, the disclosed systems and/or methods can be used to ensure that it will not unlock or will get be locked.

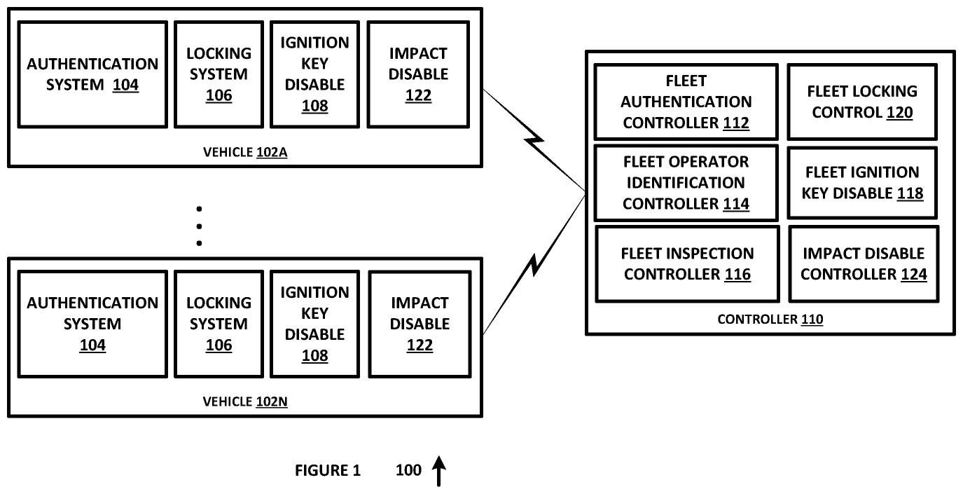

FIG. 1 is a diagram of a system 100 for managing a fleet of robotic vehicles, in accordance with an example embodiment of the present disclosure. System 100 includes vehicles 102A through 102N, each of which include an authentication system 104, a locking system 106, an ignition key disable 106 and an impact disable 122, and controller 110, which includes fleet authentication controller 112, fleet operator identification controller 114, fleet inspection controller 116, fleet locking control 120, fleet ignition key disable 118 and impact disable controller 124, each of which can be implemented in hardware or a suitable combination of hardware and software.

Vehicles 102A through 102N can be robotic or remotely controlled vehicles that include an onboard processor, communications systems for wireless communications, location data systems, sensory data systems for receiving image data, audio data, acceleration or deceleration data and other suitable data for controlling operation of the associated vehicle. In one example embodiment, vehicles 102A through 102N can include one or more processor-controlled actuators, hydraulic systems, electric systems or other suitable systems that allow the vehicle to be automatically or remotely controlled to allow them to start or stop, turn, go forward or go in reverse, brake, accelerate or decelerate and to implement other suitable functions.

Authentication system 104 can be implemented as one or more algorithms that are installed on a memory device of a data processor that cause the data processor to perform algorithmic steps when loaded that control one or more authentication devices or processes for an associated vehicle. In one example embodiment, authentication system 104 can cause an authentication device to activate when a proximity sensor actuates or when a user attempts to operate the vehicle, such as by activating a control, turning a steering wheel, depressing a brake or accelerator pedal or performing other actions. Authentication system 104 can prompt the user to enter predetermined data, use a predetermined authentication device or use other suitable devices or processes, and can determine whether user credentials are associated with an approved user. In one example embodiment, authentication system 104 can authenticate a user for predetermined tasks, for operation in a predetermined area or at predetermined times or in other suitable manners. Authentication system 104 can also receive a remote override control from controller 110 or other suitable systems that allows a user to be authenticated by a remote system operator, such as if a user has contacted the remote system operator to report an unsafe condition and needs to move the associated robotic vehicle or for other suitable purposes.

Locking system 106 can be implemented as one or more algorithms that are installed on a memory device of a data processor that cause the data processor to perform algorithmic steps when loaded that cause a vehicle to be locked or unlocked. In one example embodiment, locking system 106 can remotely lock a vehicle by disabling a starter, by operating a door lock mechanism, by disabling an electrical system or by causing other systems to be inoperable. Likewise, locking system 106 can remotely unlock a vehicle by enabling a starter, by opening a door lock mechanism, by enabling an electrical system or by causing other systems to be operable. Locking system 106 can also receive a remote override control from controller 110 or other suitable systems that allows a vehicle to be locked or unlocked by a remote system operator, such as if a user has contacted the remote system operator to report an unsafe condition and needs to lock or unlock the associated robotic vehicle or for other suitable purposes.

Ignition key disable 108 can be implemented as one or more algorithms that are installed on a memory device of a data processor that cause the data processor to perform algorithmic steps when loaded that cause an ignition key system to be switched between enabled and disabled. In one example embodiment, the ignition key system can be in an enabled state and can be disabled in response to a disable command, can be in a disabled state and can be enabled in response to an enable command or other suitable processes can also or alternatively be performed. Ignition key disable 108 can generate status data that identifies whether the ignition key system is enabled or disabled, can interface with other system components of system 100 and can perform other suitable functions. Ignition key disable 108 can also receive a remote override control from controller 110 or other suitable systems that allows an ignition key to be disabled or enabled by a remote system operator, such as if a user has contacted the remote system operator to report an unsafe condition and needs to move the associated robotic vehicle or for other suitable purposes.

Impact disable 122 can be implemented as one or more algorithms that are installed on a memory device of a data processor that cause the data processor to perform algorithmic steps when loaded that detect whether an impact has occurred and to disable the vehicle to prevent it from being moved. In one example embodiment, impact disable 122 can receive accelerometer data, audio data or other suitable data, can determine whether an impact has occurred from the sensor data, can generate a disable signal that causes a locking system ignition key disable system or other suitable systems to activate and can perform other suitable functions. Impact disable 122 can also receive a remote override control from controller 110 or other suitable systems that allows impact disable to be activated or deactivated by a remote system operator, such as if a user has contacted the remote system operator to report an impact or for other suitable purposes.

Controller 110 can be implemented as one or more algorithms that are installed on a memory device of a data processor that cause the data processor to perform algorithmic steps when loaded that control an associated vehicle and its components and subsystems. In one example embodiment, controller 110 can be an automated vehicle controller that is configured to be augment or update a vehicle to include one or more components of system 100 after installation, to determine a state of a vehicle or to perform other suitable functions.

Fleet authentication controller 112 can be implemented as one or more algorithms that are installed on a memory device of a data processor that cause the data processor to perform algorithmic steps when loaded that allow a fleet operator to generate one or more user interface controls to facilitate fleet authentication functions. In one example embodiment, fleet authentication controller 112 can allow a user to generate fleet authentication status controls, to modify the authentication controls for an individual vehicle or groups of vehicles, to allow one or more predetermined operators to be authenticated for operating the vehicle or groups of vehicles, and can perform other suitable functions.

Fleet operator identification controller 114 can be implemented as one or more algorithms that are installed on a memory device of a data processor that cause the data processor to perform algorithmic steps when loaded that allow a fleet operator to generate one or more user identification controls to facilitate fleet vehicle user identification functions. In one example embodiment, fleet operator identification controller 114 can allow a user to generate fleet vehicle identification status controls, to modify the identification processes used to allow an operator to access an individual vehicle (such as to enable or disable a biometric sensor, to configure the biometric sensor for an operator) and can perform other suitable functions. Fleet operator identification controller 114 can also identify vehicles that require service, such as in response to a recall notice, and can schedule the vehicles for an associated service so as to optimize the time required to modify all of the vehicles in response to the recall notice. In this manner, the length of time required to update the fleet can be minimized and the use of time of skilled maintenance personnel can be maximized. This can be advantageous when the maintenance personnel are visiting from a manufacturer and have overhead associated with remaining on site longer than necessary.

Fleet inspection controller 116 can be implemented as one or more algorithms that are installed on a memory device of a data processor that cause the data processor to perform algorithmic steps when loaded that causes a vehicle to be disabled if it is due for an inspection. In one example embodiment, fleet inspection controller 116 can track inspection data for each vehicle in a fleet and can generate operator warnings to alert an operator to an impending inspection deadline, to allow the operator to take the vehicle to an inspection station. Fleet inspection controller 116 can generate temporary overrides to provide a short amount of additional time if the vehicle has become disabled and it is not near an inspection station or can perform other suitable functions.

Fleet locking control 120 can be implemented as one or more algorithms that are installed on a memory device of a data processor that cause the data processor to perform algorithmic steps when loaded that allow a fleet operator to implement one or more locking operations. In one example embodiment, fleet locking control 120 can generate a user interface that displays a lock status of each vehicle in the fleet, can allow a user to select one or more of the vehicles and to change the lock state of the vehicles and to perform other suitable functions.

Fleet ignition key disable 118 can be implemented as one or more algorithms that are installed on a memory device of a data processor that cause the data processor to perform algorithmic steps when loaded that allow a fleet operator to implement one or more ignition key disable or enable operations. In one example embodiment, fleet ignition key disable 118 can generate a user interface that displays an ignition key status of each vehicle in the fleet, can allow a user to select one or more of the vehicles and to change the state of the ignition key and to perform other suitable functions.

Impact disable controller 124 can be implemented as one or more algorithms that are installed on a memory device of a data processor that cause the data processor to perform algorithmic steps when loaded that allow a fleet operator to implement one or more impact disable operations. In one example embodiment, impact disable controller 124 can generate a user interface that displays an impact disable status of each vehicle in the fleet, can allow a user to select one or more of the vehicle and to change the impact disable settings of the vehicles and to perform other suitable functions.

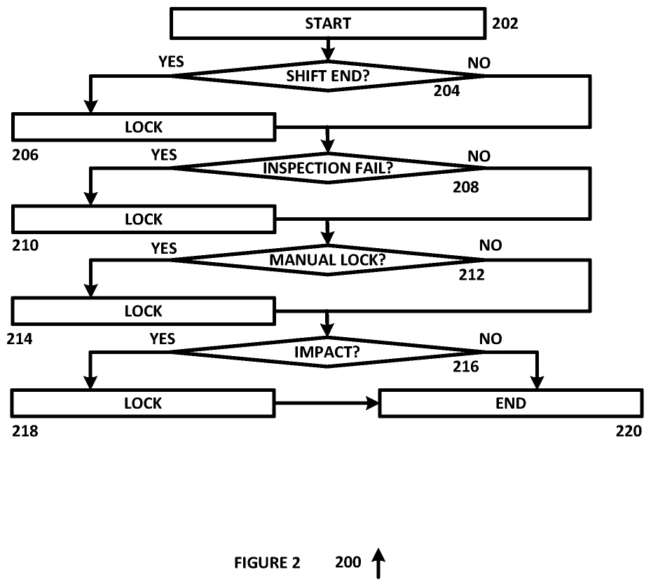

FIG. 2 is a diagram of an algorithm 200 for managing a fleet of robotic vehicles, in accordance with an example embodiment of the present disclosure. Algorithm 200 can be implemented in hardware or a suitable combination of hardware and software.

Algorithm 200 begins at 202, where a start control is received. In one example embodiment, the start control can be received from an ignition key, a proximity sensor or in other suitable manners. The start control can include one or more user authentication processes that can identify whether a user is present and is authorized to operate the vehicle, or other suitable processes. The algorithm then proceeds to 204.

At 204, it is determined whether a shift end has occurred. In one example embodiment, a shift end can be identified as a function of a shift period associated with an operator of the vehicle, a factory location or other suitable functions. If it is determined that a shift end has occurred, the algorithm proceeds to 206 where the vehicle is locked, such as by actuating a locking mechanism, disabling an ignition key system or in other suitable manners. Otherwise, the algorithm proceeds to 208.

At 208, it is determined whether an inspection fail has occurred. In one example embodiment, an inspection period can be identified, where the failure to get or pass an inspection is defined as an inspection failure. If it is determined that an inspection fail has occurred, the algorithm proceeds to 210 where the vehicle is locked, such as by actuating a locking mechanism, disabling an ignition key system or in other suitable manners. Otherwise, the algorithm proceeds to 212.

At 212, it is determined whether a manual lock command has been received. In one example embodiment, a manual lock can be actuated by a vehicle operator, a fleet controller or in other suitable manners. If it is determined that a manual lock command has been received, the algorithm proceeds to 214 where the vehicle is locked, such as by actuating a locking mechanism, disabling an ignition key system or in other suitable manners. Otherwise, the algorithm proceeds to 214.

At 214, it is determined whether an impact has been detected. In one example embodiment, an impact can be detected from acceleration or deceleration data, audio data or other suitable data. If it is determined that an impact has been detected, the algorithm proceeds to 216 where the vehicle is locked, such as by actuating a locking mechanism, disabling an ignition key system or in other suitable manners. Otherwise, the algorithm proceeds to 218 and terminates.

In operation, algorithm 200 allows a lock state of an automated or robotic vehicle to be controlled, such as by detecting whether one or more different states exist that should result in a change in the lock state. While algorithm 200 is shown as a flow chart, a person of skill in the art will recognize that it can be implemented as a state diagram, a ladder diagram, using object oriented programming or in other suitable manners.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. A software system is typically created as an algorithmic source code by a human programmer, and the source code algorithm is then compiled into a machine language algorithm with the source code algorithm functions, and linked to the specific input/output devices, dynamic link libraries and other specific hardware and software components of a processor, which converts the processor from a general purpose processor into a specific purpose processor. This well-known process for implementing an algorithm using a processor should require no explanation for one of even rudimentary skill in the art. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. A system can receive one or more data inputs, such as data fields, user-entered data, control data in response to a user prompt or other suitable data, and can determine an action to take based on an algorithm, such as to proceed to a next algorithmic step if data is received, to repeat a prompt if data is not received, to perform a mathematical operation on two data fields, to sort or display data fields or to perform other suitable well-known algorithmic functions. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A system for managing a fleet of robotic vehicles comprising:
a plurality of robotic vehicles, each including a processor controller operating under algorithmic control, wherein the processor controller of each vehicle is configured to prevent operation of the robotic vehicle by an unauthorized user; and
a central controller operating on a remote processor, wherein the remote processor is configured to interface with the plurality of robotic vehicles and to modify data associated with an authorized user for each of the plurality of robotic vehicles.

2. The system of claim 1 wherein the processor controller for one or more vehicles is configured to prevent operation of the robotic vehicle by controlling an authentication system.

4. The system of claim 1 wherein the processor controller for one or more vehicles is configured to prevent operation of the robotic vehicle by controlling a locking system.

5. The system of claim 1 wherein the processor controller for one or more vehicles is configured to prevent operation of the robotic vehicle by controlling an ignition key disable system.

6. The system of claim 1 wherein one or more vehicles further comprises an impact disable system that is configured to prevent operation of the robotic vehicle after an impact has been detected.

7. The system of claim 1 wherein the central controller is configured to determine whether the user is associated with a predetermined fleet of robotic vehicles and to authorize operation of a vehicle of the fleet of robotic vehicles if it is determined that the user is associated with the fleet of robotic vehicles.

8. The system of claim 1 wherein the central controller is configured to determine whether a vehicle requires a scheduled inspection and to generate a notice to an operator of the vehicle indicating a time limit before the vehicle will disabled if it is not inspected.

9. The system of claim 1 wherein the central controller is configured to disable a vehicle if the vehicle requires a scheduled inspection.

10. The system of claim 1 wherein the central controller is configured to interface with an impact disable system of a vehicle and to modify an impact setting that will disable the vehicle.

11. A method for managing a fleet of robotic vehicles comprising:
receiving a user identification at a vehicle;
transmitting a data communication to a central controller with the user identification;
determining whether the user identification is associated with an authorized user;
if it is determined that the user identification is not associated with an authorized user, transmitting a disable command to the vehicle; and
if it is determined that the user identification is associated with an authorized user, transmitting an enable command to the vehicle.

12. The method of claim 11 wherein receiving the user identification comprises controlling an authentication system.

13. The method of claim 11 wherein transmitting a disable command comprises controlling a locking system.

14. The method of claim 11 further comprising transmitting a disable command comprises controlling an ignition key disable system.

15. The method of claim 11 further comprising:
transmitting impact data to the central controller; and
transmitting a disable command to the vehicle.

16. The method of claim 11 further comprising:
determining whether the user is associated with a predetermined fleet of robotic vehicles; and
authorizing operation of a vehicle of the fleet of robotic vehicles if it is determined that the user is associated with the fleet of robotic vehicles.

17. The method of claim 11 further comprising:
determining whether a vehicle requires a scheduled inspection; and
generating a notice to an operator of the vehicle indicating a time limit before the vehicle will disabled if it is not inspected.

18. The method of claim 11 further comprising disabling a vehicle if the vehicle requires a scheduled inspection.

19. The method of claim 11 further comprising interfacing with an impact disable system of a vehicle and modifying an impact setting that will disable the vehicle.

20. In a system for managing a fleet of robotic vehicles that includes a plurality of robotic vehicles, each including a processor controller operating under algorithmic control, wherein the processor controller of each vehicle is configured to prevent operation of the robotic vehicle by an unauthorized user, a central controller operating on a remote processor, wherein the remote processor is configured to interface with the plurality of robotic vehicles and to modify data associated with an authorized user for each of the plurality of robotic vehicles, wherein the processor controller for one or more vehicles is configured to prevent operation of the robotic vehicle by controlling an authentication system, wherein the processor controller for one or more vehicles is configured to prevent operation of the robotic vehicle by controlling a locking system, wherein the processor controller for one or more vehicles is configured to prevent operation of the robotic vehicle by controlling an ignition key disable system, wherein one or more vehicles further comprises an impact disable system that is configured to prevent operation of the robotic vehicle after an impact has been detected, wherein the central controller is configured to determine whether the user is associated with a predetermined fleet of robotic vehicles and to authorize operation of a vehicle of the fleet of robotic vehicles if it is determined that the user is associated with the fleet of robotic vehicles, wherein the central controller is configured to determine whether a vehicle requires a scheduled inspection and to generate a notice to an operator of the vehicle indicating a time limit before the vehicle will disabled if it is not inspected, wherein the central controller is configured to disable a vehicle if the vehicle requires a scheduled inspection, and wherein the central controller is configured to interface with an impact disable system of a vehicle and to modify an impact setting that will disable the vehicle, a method comprising:
receiving a user identification at a vehicle;
transmitting a data communication to a central controller with the user identification;
determining whether the user identification is associated with an authorized user;
if it is determined that the user identification is not associated with an authorized user, transmitting a disable command to the vehicle;
if it is determined that the user identification is associated with an authorized user, transmitting an enable command to the vehicle;
wherein receiving the user identification comprises controlling an authentication system;
wherein transmitting a disable command comprises controlling a locking system;
transmitting a disable command comprises controlling an ignition key disable system;
transmitting impact data to the central controller;
transmitting a disable command to the vehicle;
determining whether the user is associated with a predetermined fleet of robotic vehicles;
authorizing operation of a vehicle of the fleet of robotic vehicles if it is determined that the user is associated with the fleet of robotic vehicles;
determining whether a vehicle requires a scheduled inspection;
generating a notice to an operator of the vehicle indicating a time limit before the vehicle will disabled if it is not inspected;
disabling a vehicle if the vehicle requires a scheduled inspection; and
interfacing with an impact disable system of a vehicle and modifying an impact setting that will disable the vehicle.
